(19) United States
(12) Patent Application Publication
(10) Pub. No.: US 2008/0256823 A1
(43) Pub. Date: Oct. 23, 2008

(54) Timber Processing

(76) Inventor: Andrew Karl Knorr, Victoria (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/576,127

(22) PCT Filed: Sep. 26, 2005
(86) PCT No.: PCT/AU2005/001465

§ 371 Date: Feb. 4, 2008

(30) Foreign Application Priority Data
Sep. 27, 2004 (AU) 2004905537

(51) Int. Cl. B27M 1/02; B27M 1/00

(52) U.S. Cl. 34/399; 144/335; 144/359; 144/380; 144/352

(57) ABSTRACT

A process for changing the properties of the wood in timber by applying varying pressure progressively along the length of the timber. The timber is caused to contract to facilitate the removal of wood water along the grain of the timber, to bend or straighten the timber, to assist the timber in contracting to its strunk state or to a state of increased density and to facilitate gluing of the processed timber. To facilitate the process timber can be heated by micro or radio waves, by direct heat or an electrical current can be applied to the timber. The heating means is generally also applied progressively along the length of the limber. The planes of pressure contact as applied to timber surfaces are not parallel to each other.

The present invention provides for a method or process to make timber suitable for end use requirements providing a process of pressure application to change the properties of the wood in the timber to make the timber more suited to end user requirements. The process can be used to facilitate timber drying or seasoning, compressing, straightening or bending and gluing.

### BACKGROUND TO THE INVENTION

Properties of wood that can affect timber are moisture content, density, drying characteristics and stresses. Different stresses have different causes and effects but lead to warping, twisting, cupping, bowing or spring which are timber terms that relate to describing timber that is not flat or straight and to splitting or cracking of the timber on the surface or internally.

In conventional drying or seasoning of timber is usually dried in the open air or in kilns and quite often in a combination of the two methods. Also there are alternative measures such as vacuum, microwave and pressure drying. The aim of drying or seasoning is to remove water from the wood so that the wood is seasoned. Seasoned or dried timber is generally considered to be timber that has a final moisture content of between 8% and 16%.

Generally the quicker the timber is dried the more degrade problems are associated with it. Degrade caused by drying are such things as checking or splitting, warping, twisting and collapse. An example relating to drying times would be the drying or the Pinus Radiata species of softwood. High temperature drying of structural timber in which some small splits, for example, are acceptable may take less than a day and but drying high quality furniture timber of the same species may take weeks. Generally softwoods can be dried more quickly than hardwoods.

General drying times for hardwood species would be in the order of months rather than days. Collapse is a particular problem of drying some types of hardwoods. Timbers with this propensity to collapse includes much of the timber sawn from the hardwood eucalypt species which are common plantation trees that are increasingly being used for the production of sawn timber.

Unseasoned wood contains free water or water held in the cells and water that is electrically bonded to the walls of the cells. Research by others shows that water can move between ten thousand and thirty thousand times more quickly along the grain than across the grain. When water rapidly evaporates out the end grain, capillary action causes low pressure inside the cells. In certain hardwoods, if moisture cannot diffuse through the cell walls into the low pressure area quickly enough, the cell wall collapses. Collapse is a the major problem in the removal of the free water in wood and the drying of timber down to Fiber Saturation Point (FSP) or the point where only the bound water in the cell walls and water vapor remain. Moisture loss (free water) has to be severely restricted in the early stages of drying so that collapse and associated internal checking do not occur. In hardwood drying it is common practice to coat the end of the timber with a substance to slow down or stop moisture loss out the end grain of the timber which forces moisture to move slowly across the grain.

Forestry California provides the following definition: “Collapse: Severe distortion or flattening of single cells or rows of cells in wood during drying often evidenced by a caved-in or corrugated appearance of the surface of the piece. (Collapse is caused by excessive compressive stress—usually related to high temperatures and low specific gravity—and excessive surface tension caused by capillary movement of water above the FSP—usually related to small pit openings.)” Removing the free water in eucalyptus is a big problem in the drying of the timber. In their document AN INDUSTRIAL PROPOSAL FOR DRYING GALICIAN Eucalyptus Globulus, Vázquez and Saavedra document the necessity of maintaining suitable conditions for the regulated removal of free water down to FSP and document that while it takes far less energy to remove, removal of free water takes around half of the total drying time and can be more difficult to manage than the actual kiln or energy input drying.

In conventional air and kiln drying rates of drying are controlled so that most moisture loss takes place in an as regulated manner as is possible, across the grain and through the side walls of the wood cells and the timber section.

Holding timber for long times while it seasons is expensive and high amounts of degrade adds additional expense. It has long been an object of research and development to find a way to economically and reliable season timber with minimal degrade.

Alternatives that have arisen include microwave and radio wave drying where water molecules are agitated to cause friction and heat and pressure within the wood to enable a more rapid drying. Unless care is taken collapse and degrade can still occur but the biggest disadvantage of microwave drying appears to be high energy requirements and a high cost of maintaining the equipment.

Recent developments have been made by Torgovnikov, Vinden and others as indicated by their USA Patent Application 20040115460. This and their associated applications point to a method of applying microwaves to timber in a manner that causes a build up of pressure within the wood cells so that the walls or other pathways for water movement across the grain are ruptured or expanded which allows for a pathway to the wood water to exit the timber more easily across the grain. The method also allows for chemical treatments to be more easily impregnated back into the wood.

Arboreo Technologies based on Patent WO 020605040 have a pressure and convection drying system that uses platens between layers of timber to heat the timber and hydraulic pressure to evenly compress the timber which does encourage moisture loss along the grain.

Some systems combine alternative technologies. Primary Driving Force in Wood Vacuum Drying by Zhangjing Chen is a scientific paper on vacuum/microwave drying that concludes most moisture loss in this type of drying is from out the end grain of the timber in the longitudinal direction and that little or no moisture is lost out the side walls of the timber section.

An Australian Government Forest and Wood Products Research and Development Corporation (FWPRDC) report entitled Thermomechanical Densification of Timber: Initial Investigation of the Potential of Softwood Timber dated April 2005 investigates the application of even pressure to softwood samples to densify and remove moisture from the timber. The report concludes with the recommendation that further research be carried out on densification using rollers and progressive feed which is covered in the current invention. While the FWPRDC report discuses the possibility of heated rollers to compress and dry the timber and while this may have merit indications from the body of the report show that heating the timber is this way is likely to be slow. In the report, times given to remove moisture to a seasoned level by heating and compression are around two hours. If this was done using rollers the timber would have to move very slowly or the roller setup would have to be very long. While this may be viable the slowness factor is increased if the timber is thicker or multiple timbers are to be dried to increase throughput rate as most heat transfer would appear to be by convention. The report records problems with surface and internal splitting during compression. Partly this problem could be the result of the plate press just flattening the timber and not allowing or assisting the wood to reach its shrunk or seasoned dimension across its width leading to stresses high enough to cause partial splitting.

Lee in U.S. Pat. No. 5,937,925 and others disclose microwave heating and compression of wood but also in the one plane and appear to indicate a substantial flattening and compression of the wood cells in the one direction.

### DESCRIPTION OF THE CURRENT INVENTION

The basic process of the current invention involves the application of pressure to the wood in a piece of timber in a way that involves applying more, or a different pressure, along the length of a piece of timber at one part than at another part along the length of the timber. Pressure or amounts of pressure is applied progressively along the length of the timber. The application of pressure means that at a certain time the timber contracts in a controlled manner more at one point along its length than at another point along its length. The pressure can be applied progressively along the length in increasing amounts or in increasing and decreasing amounts. Other methods utilizing pressure as disclosed on the prior art all use methods in which the aim is to apply pressure as evenly as possible to the wood in the piece or pieces of timber to be modified or pressure in one direction. While a major use of this invention will be for water removal from timber other uses include compression for densifying timber and the controlled straightening or bending and curving of timber and the facilitation of gluing and laminating timber by the application of pressure on different planes related to the surface of the timber and to contact points for application of pressure on the timber.

Generally the process is applicable to green or unseasoned timber and also generally the process would be suited to taking place soon after sawing when moisture content is high although the application can be made at any stage of moisture content or seasoning or processing for other purposes.

The primary objective of the drying or seasoning aspect of the current invention is to assist the water and moisture in the wood travel along the grain and the longitudinal axis of the timber section so that a significant amount of water removed during the process exits the end grain of the timber and so that this removal is done in a manner that is quicker and or less expensive and or produces less drying degrade than normal in the industry.

Wood, as part of a growing tree, is designed to transport water and nutrients along its cells. The object of this invention is to take advantage of this natural design and natural process and to encourage water and moisture movement in the same way.

The method has for its object the elimination of the problem of collapse caused by the removal of free water in the cells. When free water is pushed by compression and expansion from one end of the timber section towards the other end, the water traveling away from the starting or initial pressure end draws in air from the atmosphere to replace the free water in the cells. This breaks the chain of evaporation and capillary action that leads to low pressure and collapse.

One embodiment of the current invention to get around the problem of using convective heat has for its objective the introduction of heat quickly to the wood to keep potential drying or moisture reduction times to a minimum. One way is by applying radio waves or microwaves to the timber. Application of micro and radio waves to timber is well documented in a variety of industry publications. Agitation of the water molecules in the wood by the application of radio or micro waves causes heating of the timber and a rise in pressure.

One primary objective of the current process is to apply pressure at one part of the length of timber while applying less or no pressure at another part of the timber to keep the wood cells open in the other section of timber to allow for the freest movement of the wood water along the cells. Application of pressure can also assist in opening up cells that are blocked or restricted to facilitate flow or movement. Progressive compression can push the free water along the timber in front of the compressed area. Heat and a rise in internal pressure ahead of the physical pressure compression can facilitate the movement of water. An optimum situation would entail supplying enough power to the process so that rupturing of the cells and associated openings across the grain was kept to a minimum or was non existent but so that maximum pressure was applied in pushing moisture along the grain and the longitudinal axis and the length of the timber. Rollers or pressure plates could be used to restrict expansion to minimize the effects of rupturing, if any, and expansion of the timber, if any, caused by internal pressure. Application of heat by micro or radio waves could be applied at different stages along a board. When free water was removed and the wood was partly compressed application or introduction of heat into the wood could expand the cells and move cell water from the walls into the cavities where the moisture could be carried along the grain to be expelled out of exposed end grain. This process could be repeated as necessary until the required amount of moisture was removed. This may be at any rate such as when the timber was completely seasoned or when free water was removed from the cells and timber may be further seasoned or dried by means as is normal to the industry.

Another embodiment involves the application of electrical current to the timber where rollers or plates or other contacts could apply the necessary electrical connections to enable the current to flow in the timber. While short wavelengths are effectively generated by an alternating electrical current for the purpose of this invention application of current refers to the application of cycles and voltages below that which would be generally used in radio wave heating. Studies on electrical resistance moisture meters show current flows relatively freely in high moisture content wood and that direct current flows more easily than alternating current. Either type of current could be used to heat and agitate and dislodge water molecules. While alternating current affects the water by reversing orientation of molecules direct current orientates water molecules and allows for more continuous electron flows. Increasing electrical resistance as moisture content falls can automatically regulate current flows. When resistance reached a certain level it could be decided that the timber had received enough current to be sufficiently dried to a certain level and the current could be increased, reduced or stopped as required. Water molecules are electrically bonded to wood cell walls and research and experimentation can be used to find optimum current types and flows and voltages and amperages and cycles (if applicable) to facilitate water movement. Current can be applied at different stages of the process or more than once as required or different types and rates could be applied at different stages of the process. What are known as negative and positive connections would generally be made on opposite sides of the timber. These connections could be made opposite so the current flowed across the grain but connections could be made offset along the longitudinal axis to cause the current to flow across and along the grain. As a lot is unknown or of a highly scientific nature in regard to current flow and electron movement for the purpose of this invention it could be said that electrical connections could be made opposite to each other across the grain to cause current to flow essentially across the grain and connections could be made opposite and offset to each other to cause the current to flow across and along the grain.

Comment related to the previous comment about the scientific nature of some actions referred to in other sections of this specification can be made here: it is not the intent of this specification to detail actions and reactions to a scientific level.

Current could be turned on and off so that it was fed in pulses into the timber. Electrical connections could be made and electricity applied in amounts and manner so that a process of electrolysis or related to electrolysis takes place in the timber or on the timber at the electrical contact point with conversion of the water or a certain amount of the water to hydrogen and oxygen. Being lighter than air the hydrogen could be relatively easily collected. This hydrogen could be used as fuel to generate electricity for the system or could be used for other purposes. All or selected fluids and gases produced by the process of the invention could be collected and used.

Micro or radio waves could be applied with a current or alternating applications could be made.

The methods of the process could be used to kill organisms or insects in the wood.

While the above methods give preferred embodiments heat could be introduced to the system by a number of means such as hot water, steam, combustion of gas and the like and while rollers could be individually heated it is likely that the amount of heat that would be lost by radiation from the rollers would require a high degree of insulation to be economic and application of the heat into the insulated area may be just as effective.

Sound or light waves or mechanical vibrations may also prove effective in assisting moisture movement.

While prior references have generally been to individual pieces of timber prior and subsequent references could apply to more than on piece of timer at a time with more than one piece of timber placed next to each other for processing.

While rollers are a logical means of applying pressure or varied pressure to a section or sections of timber plates or beam type presses could be segmented to provide progressive pressure or beam or platen presses could be angled to pressure one end of a section of timber more than the other. In a preferred embodiment timber could be block stacked and heated by radio or microwaves or steam before being compressed by the angled beam or platens. One option for steam heating could involve the placement of sawdust between the timber sections to slowdown the movement of the steam so that maximum heat can be absorbed.

While prior mention has been made to pressurizing the timber sections from the end of the section pressurizing could commence in the middle of the section and work outwards towards the ends.

In application such as angled beam presses or where multiple pieces of timber are being dried a vacuum could successfully be applied to lower the outside pressure in relation to internal pressures in the timber to facilitate the loss of moisture out the end grain

Pressure can be used to straighten, curve or bend timber. This could be done cold or heated. Pressure, most likely from rollers, could bend the timber the required amount to either straighten or permanently bend the timber. For this embodiment pressure would be applied to an area of the section where there was no support or resistance or less resistance opposite to the force applied. Two opposite restraining or pressure points would be offset to either side on the initial pressure point to allow bending. The effect of the pressure would be to compress the wood closest to the initial pressure point and stretch wood furthest from the initial point. Heat applied by means as previously described could be used to supply heat to the timber to facilitate bending as is normal to timber bending. If pressure is applied by rollers the rollers could move the timber backwards and forwards and could apply increasing amounts or pressure to progressively bend the timber section more. More curvature could be applied at different points along the timber section or the pressure points could be reversed to provide for complex curves and curves in different directions.

Timber can be compressed by application of pressure. Heat applied to wood cells causes them to become elastic at a high enough temperature. Compression of the timber section when the cells are hot allows for the wood to compress without the cell walls rupturing. The current invention allows for the compression of the timber section to an amount approximate to the amount the timber would shrink during normal seasoning. The invention also allows for compression past the point of what would be the normal shrinkage amount. This would produce what is generally referred to as densified wood which have characteristics of strength and hardness that are different to normal density wood of the same species and which may be preferred over the normal density wood.

The present invention allows for the application of pressure on more than two faces. For a rectangular piece of wood pressure may be applied to the two broad faces and the two narrow faces. It is a general object of the invention to facilitate the contraction of the timber in the way that it contracts in nature as it seasons so that it contracts and is assisted in contracting in two non parallel planes which in square and rectangular cut timber are planes that lay basically at right angles to each other along the length of the timber.

Glue can be applied at any stage of the process. It may be viable to apply glue at the start of the pressure process or the timber may be compressed and then separated slightly to allow application of suitable treatment or preparation of the surfaces as required and application of glue between the individual timbers and then compressing the timbers back together to bond two or more timbers together. Done in line with the drying of the timbers would mean that the wood would be hot which will facilitate the curing of the glue. It is anticipated that faces will “match” due to compressive forces applied earlier as when knots are present and an individual timber was being compressed the knot may require extra force to compress or a release mechanism to ride over the knot but when multiple timbers are processed the knots can move partially into adjacent timber. Knots can also be docked out and removed from the process which is normal to timber production for many products.

While the process of the invention can be applied to all types of timber it is anticipated that the process will be particularly advantageous when applied to radial sawn timber. Radial sawing has the ability to produce timber with relatively consistent growth ring alignment which leads to consistent drying characteristics. Rollers and presses can be adapted to the triangular or trapezoidal shape of radial timber sections as necessary.

While rollers and presses can have actual pressure applied a device with rollers could have the rollers set progressively closer together and fixed in position so that as the timber advances the timber is forced to contract to the size set between the rollers. Rollers can drive the timber or the timber can be driven by other means.

### DRAWINGS AND DESCRIPTIONS

The accompanying drawings details aspects of timber terminology, some prior art and significant aspects of the current invention.

FIG. 1(a) shows a rectangular end section or end grain view of a section of timber with the annular growth rings indicated by the curved lines (1), (b) the side view or side grain view of the same section along with the top view (c) which also is referred to as a side grain view. Dotted line (2) and (3) shows what is referred to as the longitudinal axis of the section of timber running along the length of the timber. The main water and nutrient transport cells of the wood basically run parallel to this axis and along the length of the timber. Arrow (4) shows the direction in relation to the timber as to what is generally referred to as along the grain and arrows (5) show the directions that are generally referred to as across the grain. As timber is cut from a natural object and may not be perfectly round or straight and are generally tapered exposed end grain can occur anywhere along the timber not just at the ends.

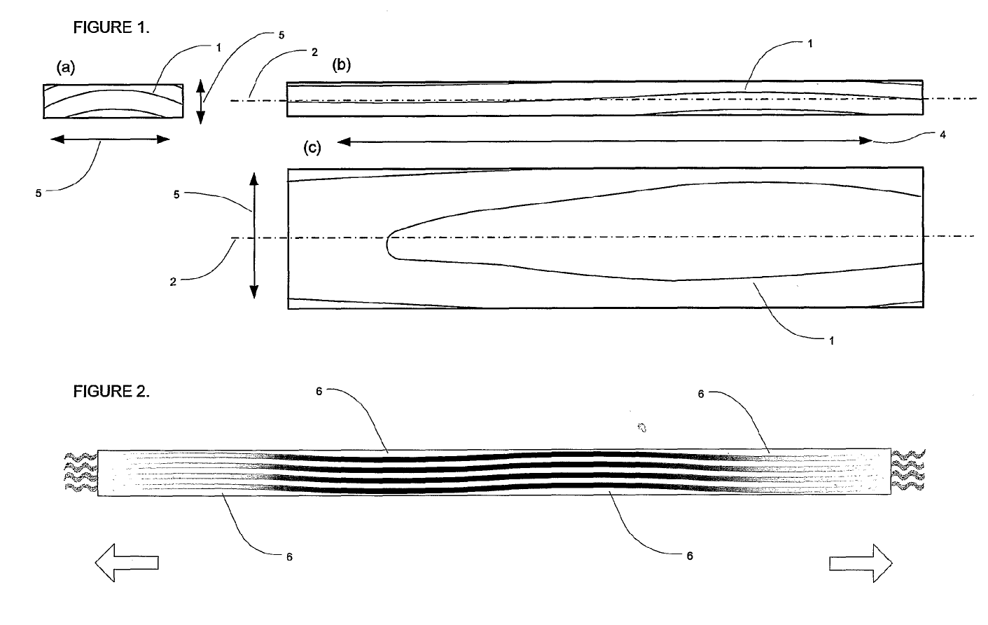

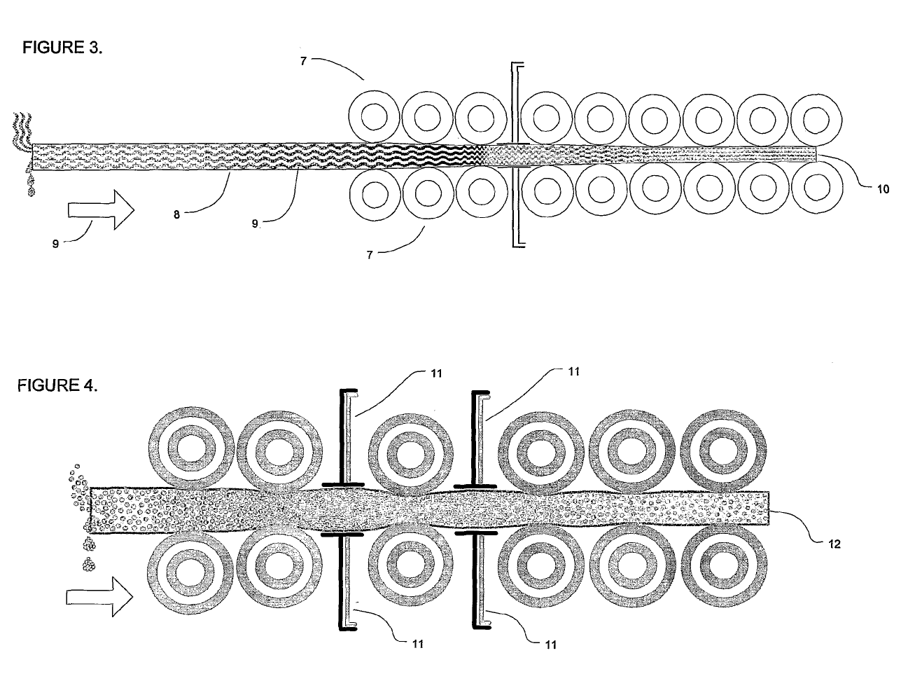

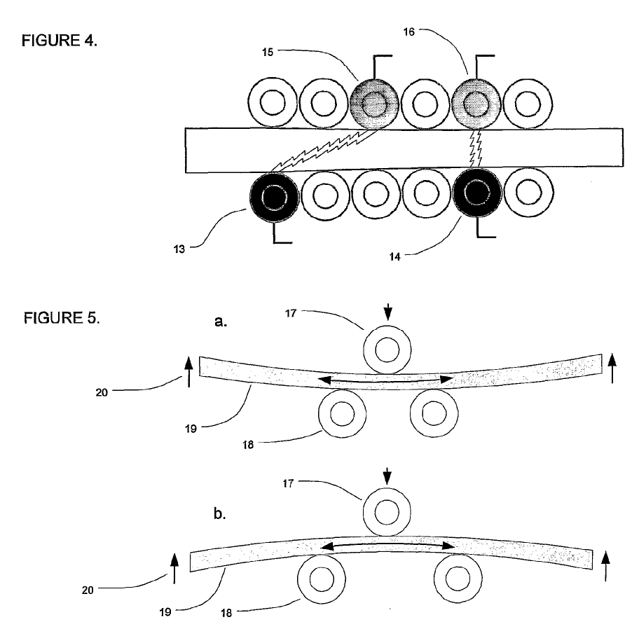

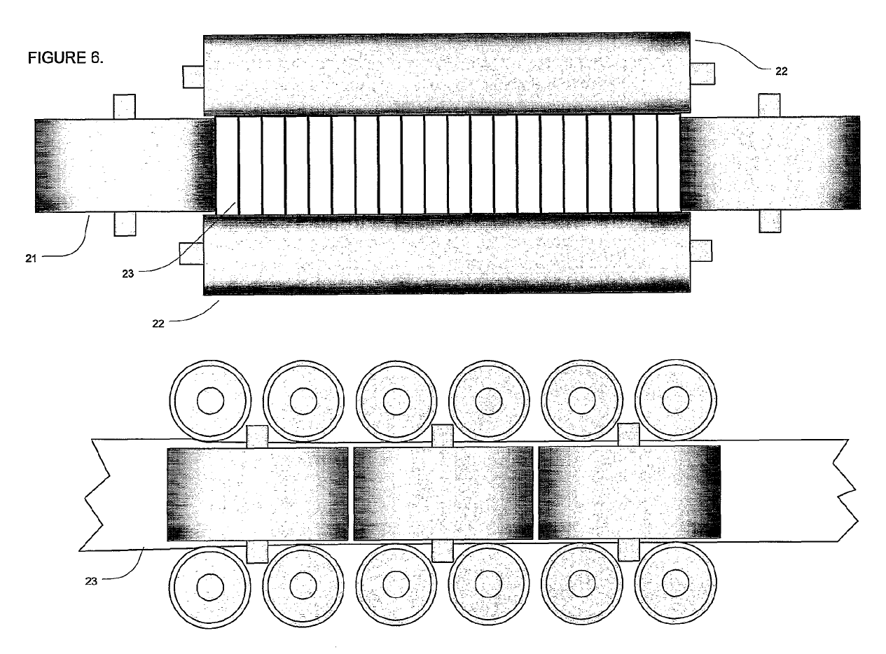

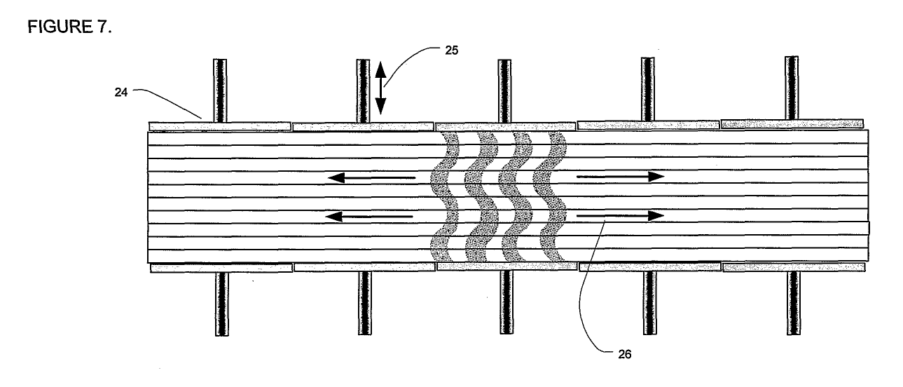

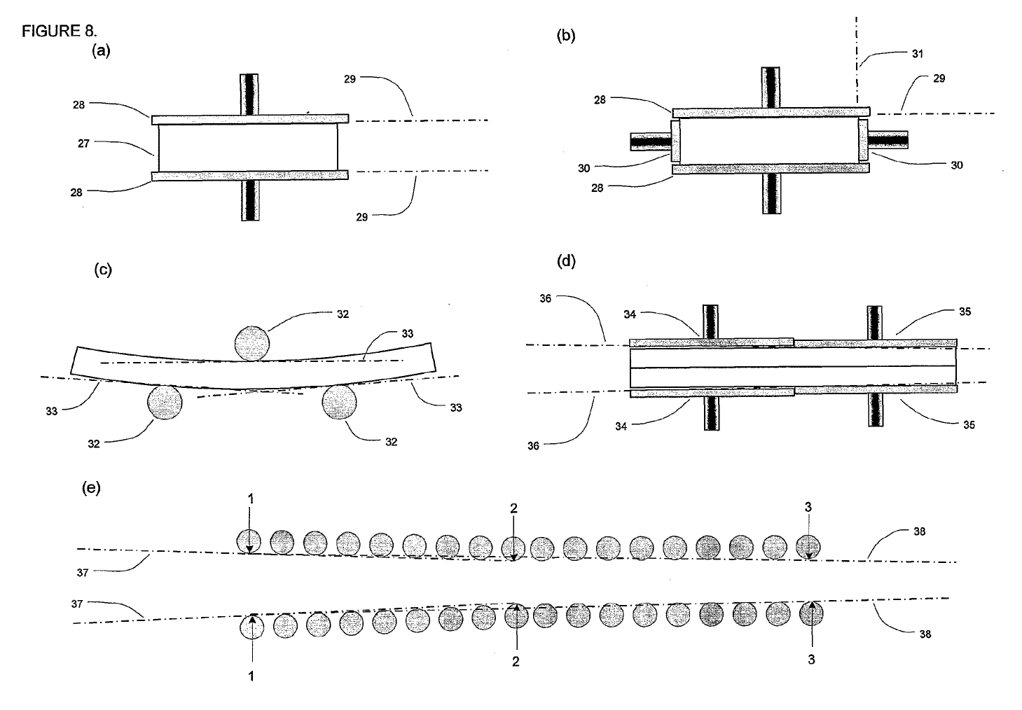

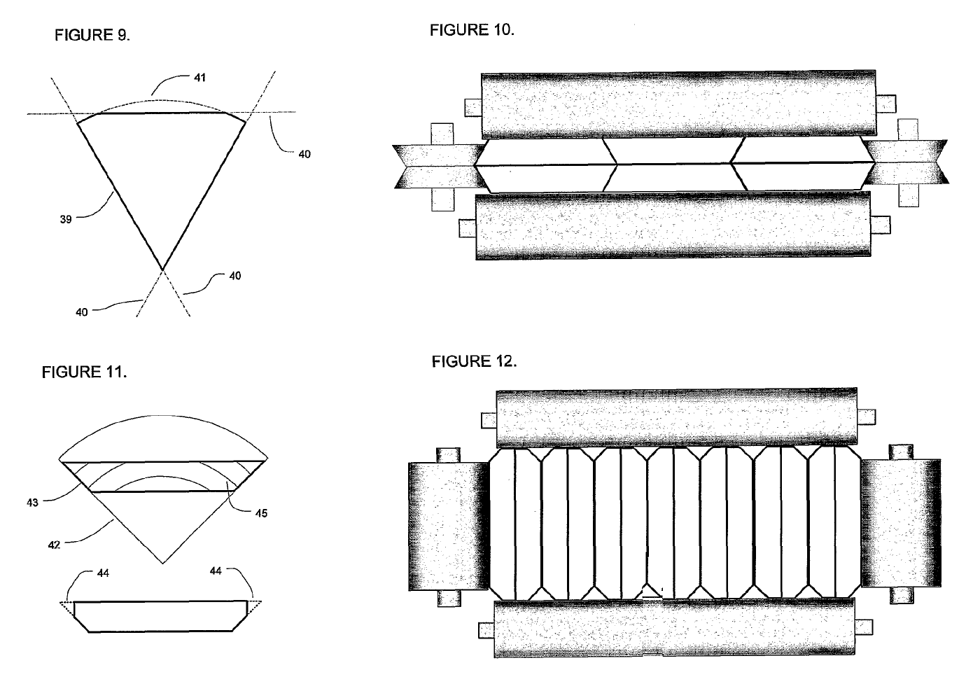

For the purpose of this invention application of pressure and contraction refers to pressure and contraction towards and at an angle to the longitudinal axis or pressure and contraction across the grain. If pressure and contraction was not at an angle to the longitudinal axis it could be parallel to the longitudinal axis and along the grain which is not the intention of this invention.

While there is some difference in word usage in industry for the purpose of this invention and in a non technical way wood refers to the cells and cellulose that is formed by nature in the tree and timber is the product that is sawn from the wood of the tree.

FIG. 2 shows a side view of a timber section with the wavy lines representing the wood water and showing evaporation out of the ends that leads to low pressure at the ends and capillary action sucking the water out of the wood which can lead to collapse and severe drying degrade. (6) shows areas with large areas of end grain exposed on the side face where surface checking and degrade would be severe in certain timber species not dried properly.

FIG. 3 shows a basic embodiment of the invention in which timber travels relative to the rollers (7) in a direction shown by the arrow at (9) where pressure is applied by pressure being applied to the rollers or the rollers are fixed with decreasing space between them to force the timber to contract to a size below or smaller than its original volume as indicated by the smaller size at exit point (10). To facilitate contraction this drawing shows a symbol representing micro or radio waves being applied to the timber to heat the timber to facilitate compression and or the travel of water along the longitudinal axis or length of the timber. The primary object of this embodiment can be to remove the moisture or to compress the timber to a required amount without specifically aiming to remove the water. Also the wood can be compressed or contracted without heat to remove some of the free water and to apply uneven pressure to one side to counteract distortion in the timber caused by growth stresses. After contraction of the cold pressed timber the natural resilience of the wood may cause the timber to basically return to its original shape or it may remain compressed to a certain degree.

FIG. 4 shows greater detail on options for application of micro or radio waves for the purpose of heating and modifying the wood properties in the timber by reducing moisture, compressing or bending. Arrow shows the relative travel direction for the timber and rollers with cold roller section at (12(i)) which may or may not compress the timber. If pressure is applied at (12(i)) as shown by the drawing it can help to facilitate a build in pressure at the heating point (11). The timber could be allowed to expand at this point assisted by internal pressure but in this application it is not anticipated that the timber would expand beyond its original dimensions. Also the amount of heating and energy applied would aim to maximize the pressure generated in wood but not above an amount so that most of the energy is dissipated by pushing water and water vapour in a direction along the longitudinal axis of the timber. Additional (11) heating points can be added as required. One object of restricting and contacting the timber on either side of the heating points is the generation of pockets of high pressure which would effectively travel the full length of the longitudinal axis of the timber. These pockets can be used to push the water in front of it along the grain. (12) shows the reduced dimension of the timber at the end of the rolling process. While FIGS. 3 and 4 indicate short operations as many rollers and heating stations could be applied as is necessary to dry or compress or bend the timber to the required level. While the heating points may be microwave generators or plates which may be normal to the application of radio waves rollers could be used to apply high frequency waves ensuring good contact with the water in the timber to reduce arcing which can be a problem in the application of high frequency waves. While a general intention of the use of rollers may be to increase the pressure and contraction or to hold even the compression and contraction, the spaces between rollers may allow for a relatively minor expansion and decrease in pressure between closely spaces rollers and a larger one between wider spaced rollers.

Any application introducing a pressure shift along the length of the timber and moisture movement in that direction will generate low pressures which will allow air and therefore moisture or liquid and or gas to be drawn in the low pressure end or the end that is getting further from the pressure point or points. By supplying or providing liquid or gas at and around the low pressure area this can be used to introduce chemicals into the timber for what the timber industry sees as beneficial purposes.

FIG. 5 is a representation of a preferred embodiment of a device and process for imparting an electrical current to the wood while also providing a compression. Rollers (15) and (16) could for example carry the positive charge and rollers (13) and (14) could carry the negative charge for direct current while for alternating current the charges would alternate. Rollers (14) and (16) are opposed to each other so the current basically travels across the grain and rollers (13) and (15) are opposed and offset so that the current travels across and along the grain. Using pressurized rollers to impart the charge to the timber has benefits as it ensures a good electrical contact with the wood water. Electrical current could be supplied to the pressure rollers by carbon brushes such as are used in a commutator and as a continues flow or intermittently or alternatively by the commutator. Rollers or plates could also be supplied with current by induction or other means that may be normal to the electrical industry.

FIG. 5 (i) a. and b. show rollers or pivot points (17) pressurizing sections of timber (20) against two opposed rollers or pivot points (18). In (a) the orientation shows how the timber can be made more concave or bent more by applying more pressure while (b) shows how a curved section of timber can be straightened by the application of pressure. So that the pressure can be distributed along the timber section the pressure and pivot points can rotate to allow or to cause the feed of the timber sections backwards and forwards along the timber's longitudinal axis relative to the rollers as indicated by the double ended arrows on the representations of the timber sections. Boards can be hot or cold rolled. This application of the process will tend to stretch the cells and wood furthest from the pressure source and contract or compress the wood closest to the pressure point. Support or some restrictive force could be applied opposite the primary pressure point to still allow the timber to bend but to allow an increase in the pressure that can be applied to the timber. This could also be achieved by moving the pivot rollers closer together. The spacing of the pivot rollers can be varied as required during the process. Green or unseasoned timber is much more flexible and pliable than dry or seasoned timber so if green timber is processed less or no heat may need to be applied. In a general reference to the process high initial moisture content at the start of processing would be a general benefit for conductivity and freedom of water movement.

The backwards and forwards movement of the timber could be applied to other variations of the pressure applications related to this invention. This could be an advantage where space is a premium and a number of pressure applications are required to achieve the desired result. Additionally, for smaller scale operations the previously described device used to bend or straighten the timber could have adjustable rollers relative to the length of the timber so the same device can be used to move moisture and compress the timber as it bends or straightens the timber. Side rollers could facilitate this.

While references may be made to sections of timber in the singular or be non specific all applications can be applied to multiple pieces of timber as is practical or convenient. Also where reference is made to compression and contraction the compression and contraction can be on more than one face or two faces. FIG. 6 shows a representation of a number of grouped rectangular boards (23) being pressurized by top and bottom rollers (22) and side rollers (21) and forced to contract of four surfaces. Similarly the all round pressure could be provided by beam or platen presses with pressure plates with flat or curved faces as required. In practice compaction devices or apparatus must allow for clearance between adjacent rollers or plates so that the required amount of compaction can be applied without interference between the adjacent pressure means.

FIG. 7 Shows a pack or multiple pieces of timber compressed by individual plates or presses (24) that can move as indicated by arrow (25) with pressure starting basically in the middle of timber to start water movement in opposite directions predominantly along the length of the timber as indicated by arrows (26). Heat could be provided at the centre as shown by wavy lines and as previously described and then as required to the ends or the pack could be heated generally. Pressure could be applied progressively by a similar apparatus starting from the end of the pack of timber to facilitate water movement. Spacer plates or sticks could be inserted between the timer layers. The basic process could be applied from one end with progressive plate pressure or conversely rollers could work from the centre to the ends of the packs.

FIG. 8 provides representations to assist in the definitions of the planes of contact that define the invention. FIG. 8(a), (27) shows an end grain view of a section of timber with pressure devices (28) and dotted lines (29) that represent the parallel planes of the pressured faces. This represents prior art application to changing the properties of wood. FIG. 8(b) provides a representation of the end grain with pressure devices (28) and with pressure devices (30) on the sides. Dotted lines (29) and (31) represent pressure planes that are not parallel which is an aspect of the current invention. FIG. 8(c) provides a representation of a side grain view of a section of timber with pressure points (32) and dotted lines (33) that represent planes at a tangent to the faces at the pressure points that are not parallel and that will also change during the process applied to the timber. FIG. 8(d) shows a representation of a side grain section of timber pressurized by side views of devices (35) applying greater pressure and degrees of compaction to the timber than device (34). Dotted lines (36) represent the non parallel planes formed by four points chosen to form part of a plane relating to the pressure faces and that will also change during the application of the process to the timber. FIG. 8(e) shows a representation of a roller pressurizing device or apparatus which apply pressure to timber and could be used for top or side compaction or both. It shows representations of two planes (37) between points on rollers 1 and 2 that are not parallel and different planes (38) formed by points on rollers 1 and 3 that are not parallel and are different along the length of pressure application. The device allows for an area of rollers, which could be pressure plates, angled to increasingly contract the timber. Rollers (or plates) shown between 1 and 2 are inline but could form a curve. Rollers (or plates) between 2 and 3 may be parallel to allow for even pressure restraint during a period of cooling or setting of cells from an elastic state caused by heat or bending.

In relation to the application of pressure the application of pressure could be only to one side of a section or piece or pieces of timber but the act of pressurising one side against a restraint has the effect of pressurizing both sides and similarly with the transmittal of pressure when pressure is applied to a number of pieces of timber side by side and the pressure is transferred. When drawings are made representing pressure devices on either side of a section of timber such as in FIG. 8(a) they are not meant to show or imply that if lower pressure device (28) was a fixed restraining bed that the intent of the drawing or the definition of the invention was different.

FIG. 9 shows a radially sawn wedge sector of timber formed by cutting radially from or through the centre of a log so that essentially there are two radial faces with a required angle between and a natural face which is or was the outside or bark edge of the log from which the wedge was cut which is shown at (41) and which is shown by the darker line as being cut or machined off at least partially to form a machined or sawn face. For the purpose of this invention dotted lines (40) show the pressure planes that are not parallel.

Radial wedges can be cut or sawn either parallel to the radial faces to make quartersawn timber or parallel to the bark edge face to make backsawn timber. This method provides for consistent processing because backsawn timber generally shrinks twice as much across the broad face as quartersawn timber so a batch of timber that can be consistently aligned into either type of cut can be processed more efficiently. While the radial wedge shows three faces more faces could be cut in preparing the timber. This could also apply to conventionally or square cut timber which could be cut with additional faces before processing by the method of the current invention.

FIG. 10 shows backsawn boards being compressed and being compressed on the edges with rollers mated to the shape of the profile caused by the profile formed by cutting across the radial faces.

FIG. 11 shows a backsawn board cut from a wide angled wedge (42) with growth rings shown as (45), a radial face shown as (43). As boards from wider wedges have sharper edges, edges can be cut of as at (44) to facilitate compression.

FIG. 12 shows a preferred embodiment of compression of radial timber sections with points of the radial edges removed.

1. A process of effecting change to the properties of the wood in a section of timber by applying pressure at an angle to, and towards, the longitudinal axis of the timber so that pressure is applied on two or more faces of the timber so that:
(i) The planes of the faces of the timber are not parallel, or;
(ii) The planes that are a tangent to the faces of the timber at pressure points are not parallel, or;
(iii) The angles between the planes formed by four pressure points on the faces of the timber are not parallel and change along the length of the timber.

2. A process according to claim 1 of effecting change to the properties of the wood in a section of timber by contracting, or applying pressure at an angle to and towards, the longitudinal axis of the timber so that at least at one stage of the process the applied pressure is greater on one part of the timber along its length than on another part along the timber's length and in which the contraction or application of the pressure along the length of the timber is intrinsic to the change of properties of the wood of the timber.

3. A method according to claim 1 in which the contraction or pressure moves or assists or facilitates or causes the movement of wood water or moisture in a direction along the length of the timber.

4. A method according to claim 1 in which the contraction or pressure moves or assists or facilitates or causes the movement of wood water or moisture in a direction substantially along the length of the timber so that during the process most water removed from the timber is out the end grain of the wood.

5. A process according to claim 1 in which the wood is heated.

6. A process according to claim 1 in which the water in the wood is heated.

7. A process according to claim 1 in which an electrical current such as is commonly known as alternating current is applied to the timber so that the current flows through the wood water.

8. A process according to claim 1 in which an electrical current such as is commonly known as direct current is applied to the timber so that the current flows through the wood water.

9. A process according to claim 1 in which electrical connections are made to the wood opposite to each other across the grain so that the current flows essentially across the grain.

10. A process according to claim 1 in which electrical connections are made to the wood offset to each other across the grain so that the current flows across the grain and along the grain.

11. A process according to claim 7 in which electrolysis takes place in or on the wood.

12. A device according to claim 7 in which rollers provide the electrical contact with the wood.

13. A process according to claim 1 in which what are commonly known as micro waves or radio waves are applied to the timber.

14. A process according to claim 13 in which a current is also applied.

15. A process according to claim 1 in which what are is commonly known as sound waves or light waves or mechanical vibrations are applied to the timber.

16. A process according to claim 1 in which heat or molecular or electron movement is introduced to or generated in the timber to increase the internal pressure related to the wood water.

17. A process according to claim 16 in which the heat or molecular or electron movement is introduced or generated progressively along the length of the timber.

18. A process according to claim 16 in which the heat or molecular or electron movement is introduced or generated In a position relative to a pressure point.

19. A apparatus according to claim 17.

20. A process according to claim 1 which incorporates the application of a vacuum to assist with moisture loss from the wood.

21. A process according to claim 1 in which an amount of pressure is applied to one part of the timber to restrict water movement in one direction along the length of the timber and in which the pressure is moved along the length of the timber.

22. A process according to claim 1 in which the pressure application is applied at a part of the timber so that there is no or less pressure or restraint on the opposing side of the timber so that the timber bends and causes a compression of the wood closest to the pressure and a stretching of the wood farthest from the pressure.

23. A process according to claim 21 in which pressure and restraint points are rollers which allow or are used to cause the timber to travel backwards and forwards relative to the longitudinal axis and relative to the rollers.

24. A product produced by processes according to claim 21 that is a generally straight piece of timber.

25. A product produced by processes according to claim 21 that is a curved or bent piece of timber.

26. A process according to claim 1 in which the timber section is fed backwards and forwards along it length relative to the pressure points.

27. A process according to claim 1 in which gases and or liquids produced by the process are collected for use.

28. A process according to claim 1 in which the timber is compressed by and amount equal or approximate to the amount that the timber would shrink during normal seasoning or drying.

29. A process according to claim 1 in which the timber is compressed by an amount greater than an amount equal or approximate to the amount that the timber would shrink during normal seasoning or drying.

30. A process according to claim 1 that includes the step of introducing chemicals to the wood by application of liquid or gas to areas of lower pressure in the wood.

31. A process according to claim 1 that includes the step of a period of another method of drying or further processing.

32. A process according to claim 1 that includes applying pressure to more than two faces of the timber.

33. A process according to claim 1 that includes the step of gluing more that one piece the processed timber together.

34. Products produced according to claim 1.

35. A device according to claim 1 that incorporates rollers that compress the timber by virtue the rollers having pressure applied to them.

36. A device according to claim 1 that incorporates rollers that compress the timber by virtue the rollers being fixed into positions that compress the wood as the timber moves past the rollers.
